(19) United States
(12) Patent Application Publication
(10) Pub. No.: US 2009/0235551 A1
(43) Pub. Date: Sep. 24, 2009

(54) AUXILIARY LAUNDRY TREATING MACHINE AND MULTIPLE LAUNDRY TREATING MACHINE INCLUDING THE SAME

(75) Inventors: Seong Jin Jo, Gyeongsangnam-do (KR); Seong Hae Jeong, Gyeongsangnam-do (KR); Deug Hee Lee, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRICS INC., SEOUL (KR)

(21) Appl. No.: 12/309,613

(22) PCT Filed: Jul. 25, 2007
(86) PCT No.: PCT/KR2007/003559

§ 371 Date: Jan. 23, 2009

(30) Foreign Application Priority Data
Jul. 25, 2006 (KR) 0-2006-0069866
Jul. 25, 2006 (KR) 10-2006-0069863

(51) Int. Cl. D06F 31/00; D06B 1/00; F26B 7/00

(52) U.S. Cl. 34/427; 68/27; 68/5 C

(57) ABSTRACT

The present invention relates to a supplementary laundry treating machine (120), and a composite laundry treating machine (110) having the supplementary laundry treating machine (120). The supplementary laundry treating machine (120) includes a body (121) having a space formed therein for holding laundry, an air supply unit (140) in the body (121) for supplying air to the space for holding laundry, and joining means (135) for securing the body (121) to one side of a laundry treating machine (110) having a volume and a height greater than a volume and a height of the body (121), respectively.

### TECHNICAL FIELD

The present invention relates to supplementary laundry treating machines. More specifically, the present invention relates to a supplementary laundry treating machine for a general laundry treating machine, and a composite laundry treating machine having the supplementary laundry treating machine and the laundry treating machine combined therewith.

### BACKGROUND ART

In general, the laundry treating machine is a machine which can wash, dry, or wash and dry the laundry. The laundry treating machine can perform a washing or drying function or both the washing and drying functions. Recently, laundry treating machines each having a steam generator are come into wide use, which has a refresh function such as removal of creases, deodoring, removal of static electricity from the laundry.

In the meantime, according to directions of laundry introduction/taking out, in related art laundry machines, there are front loading type laundry machines and top loading type laundry machines. According to washing systems, there are upright type laundry treating machines in each of which a pulsator or a washing tub rotates, and a horizontal type laundry treating machines in each of which a drum rotates. Typical examples of the horizontal type laundry treating machines are the drum type washing machines or dryers.

Currently, it is a trend that the laundry treating machines become gradually larger in correspondence to demands of users. That is, sizes of domestic laundry treating machines become larger, gradually.

In the meantime, of the related art laundry treating machines, there are cases when the washing machines are provided with the drying function. Consequently, if the user needs the drying function, provision of a dryer or a washing and drying machine is required. Accordingly, in order to perform both the washing and drying, an expense of the consumer can not, but increase.

Moreover, in the laundry treating machine having the drying function, as the laundry treating machine becomes the larger gradually, driving of the large sized dryer even in a case a small amount of laundry is dried is not favorable in view of energy saving. Moreover, drying shoes or clothes with the drum type dryer is difficult Of course, the shoes may be dried with a rack mounted in the drum, which is kept horizontal regardless of rotation of the drum, for placing the shoes thereon. However, in this case the mounting/dismounting of the rack is cumbersome.

FIG. 1 illustrates a perspective view of a related art laundry treating machine.

Referring to FIG. 1, the related art laundry treating machine is provided with a body 10 which forms an exterior of the laundry treating machine, and a control panel 11 on a front or top of the body. The control panel may be provided with a control unit for controlling operation of the laundry treating machine. Therefore, by operating the control unit, the user can treat laundry, such as washing or drying.

The laundry treating machine may be a washing machine, a dryer, or a washing and drying machine.

In the meantime, the related art laundry treating machine may be provided with a pedestal 20. In this instance, the body 10 is placed on the pedestal 20.

In general, the pedestal 20 has a space formed therein in a form of a drawer drawable in a front direction. The pedestal serves to support the body 10 and as a box for putting detergent and laundry therein.

Consequently, in the related art, the pedestal 20 fails to have any function for treating the laundry.

### DISCLOSURE OF INVENTION

### Technical Problem

To solve the problems, an object of the present invention is to provide a supplementary laundry treating machine which enables treatment of small amount of laundry, without operating a relatively larger laundry treating machine, for convenience of use and saving energy.

Another object of the present invention is to provide a composite laundry treating machine which enables an easy addition of a drying function to a laundry treating machine only with a washing function.

Another object of the present invention is to provide a composite laundry treating machine which can make easy drying of laundry and the like, such as shoes and caps which have been difficult to dry with a related art drum type dryer.

Another object of the present invention is to utilize a supplementary space, such as a pedestal for a related art laundry treating machine, as a supplementary laundry treating machine.

### Technical Solution

To achieve these objects and other advantages and in accordance with the purpose of the invention, as embodied and broadly described herein, a supplementary laundry treating machine includes a body having a space formed therein for holding laundry, an air supply unit in the body for supplying air to the space for holding laundry, and joining means for securing the body to one side of a laundry treating machine having a volume and a height greater than a volume and a height of the body, respectively.

The supplementary laundry treating machine may be installed independent from the laundry treating machine. However, it is preferable that the supplementary laundry treating machine is fixedly secured to one side of a body of the laundry treating machine with joining means, because, as the supplementary laundry treating machine is a machine of treating the laundry in supplementary, it is preferable that the laundry treating machine and the supplementary laundry treating machine are put together at one place for smooth performance of a series of laundry treating steps. Moreover, in view of space utilization, it is preferable that the supplementary laundry treating machine is put together with the laundry treating machine.

Of course, as a major machine, the laundry treating machine may be a washing machine or a dryer, for washing or drying, and a washing and drying machine. However, the laundry treating machine is not limited to this, but may also be a water extractor which performs water extraction only.

In the meantime, it is preferable that the air supply unit include a fan for blowing air, and a heater for heating the air being blown by the fan, for drying the laundry with the supplementary laundry treating machine.

Preferably, the machine may further include a control unit for controlling operation of the air supply unit, and the control unit is provided to a front of the body. Of course, preferably, the control unit includes a control panel for the user's operation, and only the control panel may be provided to the body of the supplementary laundry treating machine.

Moreover, preferably, the machine further includes a steam supply unit in the body for selective supply of steam to the space for holding laundry under the control of the control unit.

Preferably, the supplementary laundry treating machine is located under the laundry treating machine. Preferably, the space for holding laundry has a shape of a drawer which can be drawn forward from the front of the body.

The body has a rear wall with an inlet for introduction of the air into the body and an cutlet for discharging the air from the body. It is preferable that a rear wall of the drawer is in communication with the inlet and the outlet, respectively.

Preferably, the air supply unit and the steam supply unit are provided between the rear wall of the drawer and the rear wall of the body.

Of course, the rear wall of the supplementary laundry treating machine and the rear wall of the drawer may be a side wall of the body of the supplementary laundry treating machine or a side wall of the drawer. In this case, the air will be in/cut through, not the rears, but the sides of the drawer and the supplementary laundry treating machine. Therefore, since the rear or side is nothing but a difference of a reference, it may be regarded that the air in/out through the side of the supplementary laundry treating machine is included to the air in/cut through the rear of the body of the supplementary laundry treating machine.

The machine may further include a rack which divides an inside of the drawer into an upper portion and a lower portion, preferably allowing the upper portion and the lower portion to be in communication with each other for placing the laundry thereon. The rack may be tilted, and, preferably, the rack may be tilted down toward the air supply unit.

It is preferable that the machine further includes an air guide extended from an upper portion of a rear wall of the drawer to an inner side of the drawer for guiding the air to the upper portion of the drawer, for uniform supply of the air throughout the upper portion of the drawer, as well as minimizing interference between in/out air.

In another aspect of the present invention, a method for controlling a supplementary laundry treating machine having a space formed therein for holding laundry therein and selective blow of air thereto secured to one side of a laundry treating machine, includes the steps of a mode selecting step for the user to select an operation mode, and a drying step for forcible supply of air to the space for holding laundry, with an air temperature and an air supply time period varied with the operation mode the user selects.

The operation mode includes a refresh mode for refreshing the laundry. If the refresh mode is selected in the mode selecting step, a steam supply step is performed for supplying the steam to the space for holding laundry before the drying step. Of course, the user may select the operation mode of the supplementary laundry treating machine at the control panel on the laundry treating machine.

### ADVANTAGEOUS EFFECTS

Thus, the present invention permits the user to wash or dry a large amount of laundry with the laundry treating machine or dry a small amount of laundry with the supplementary laundry treating machine, thereby providing convenience of use and enabling to save energy. Moreover, laundry, such as shoes or a cap, that has been difficult to dry with a related art dry type dryer can be dried, easily.

### BRIEF DESCRIPTION OF THE DRAWINGS

FIG. 1 illustrates a perspective view of a related art laundry treating machine with a pedestal;

FIG. 2 illustrates a perspective view of a composite laundry treating machine with a supplementary laundry treating machine in accordance with a preferred embodiment of the present invention;

FIG. 3 illustrates an exploded perspective view of the supplementary laundry treating machine in FIG. 2; and

FIG. 4 illustrates a section of a composite laundry treating machine with a supplementary laundry treating machine in accordance with a preferred embodiment of the present invention, schematically.

### BEST MODE FOR CARRYING OUT THE INVENTION

Reference will now be made in detail to the specific embodiments of the present invention, examples of which are illustrated in the accompanying drawings. Wherever possible, the same reference numbers will be used throughout the drawings to refer to the same or like parts. In the meantime, as the laundry treating machine may be a general washing machine, a dryer, or a washing and drying machine, detailed description of which will be omitted.

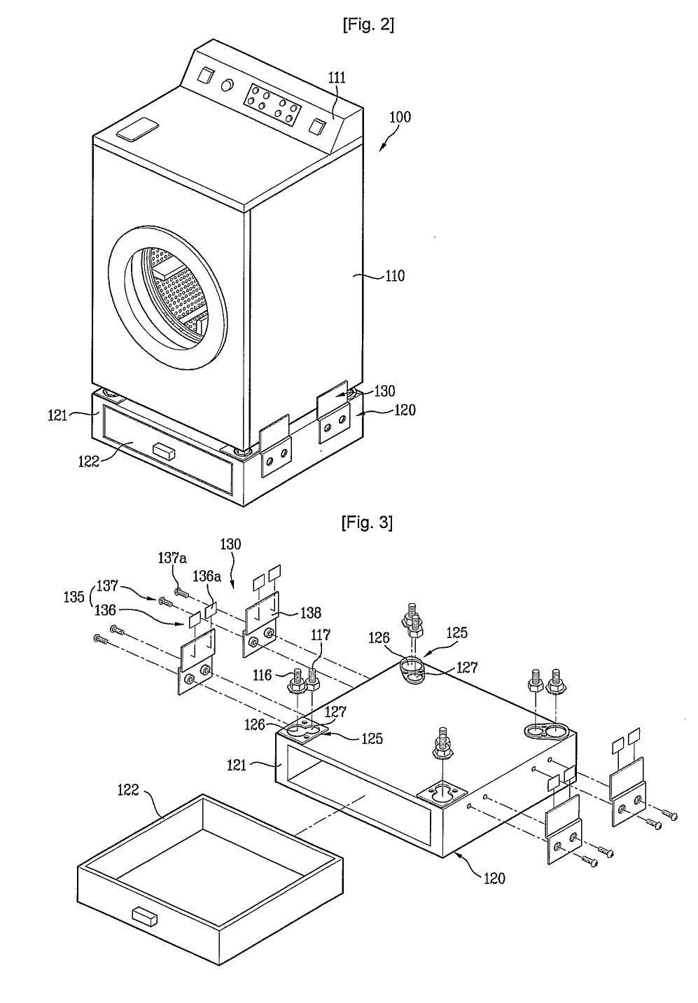

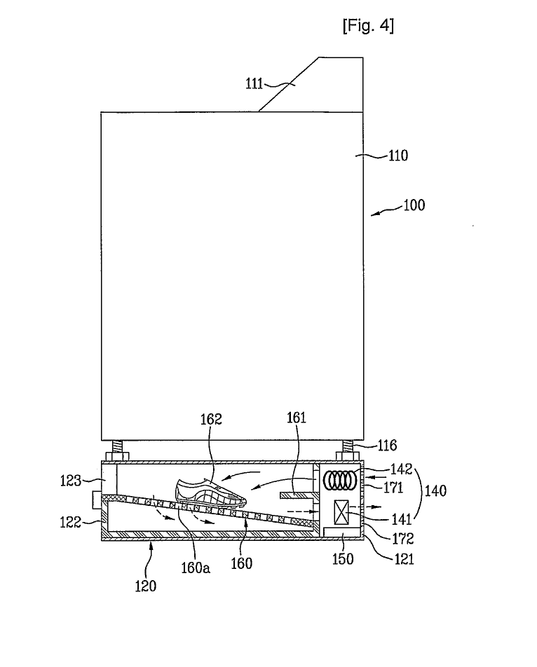

A supplementary laundry treating machine in accordance with a preferred embodiment of the present invention will be described in detail with reference to FIGS. 2 and 3.

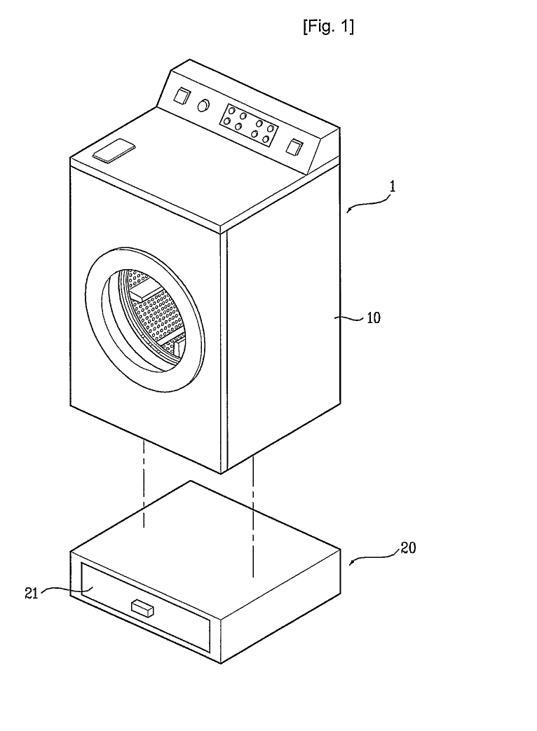

Referring to FIG. 1, the supplementary laundry treating machine may have an exterior the same with a laundry treating machine with a pedestal 20. However, as shown in FIGS. 2 and 3, the pedestal functions not only as a pedestal, but also as a supplementary laundry treating machine. In addition to this, the pedestal includes pining means 130 for fixedly securing the supplementary laundry treating machine to the laundry treating machine.

Referring to FIG. 2, the supplementary laundry treating machine is provided to one side of a body 110 of the laundry treating machine. That is, as shown in FIG. 2, the supplementary laundry treating machine may be provided to an underside of the body 110, or on a top of the body 110. In this case, it is preferable that a control unit of the laundry treating machine, particularly, the control panel 111, is provided to a front of the body 110.

Or, the supplementary laundry treating machine 120 may be provided to a side of the laundry treating machine. However, in view of space utilization or design, it is preferable that the supplementary laundry treating machine is provided to the top or the underside of the body 110 of the laundry treating machine.

In the meantime, referring to FIGS. 2 and 3, the supplementary laundry treating machine 120 includes a body 121 having a space formed therein for holding the laundry, and joining means 130 at an upper portion thereof for joining the body 110 and the body 121 together. The supplementary laundry treating machine 120 supports the body 110 of the laundry treating machine at a bottom thereof.

The supplementary laundry treating machine 120 may also include leg supporters 125 provided to a top of the supplementary laundry treating machine 120 for supporting sides of lower legs 116, and 117 of the laundry treating machine.

Each of the leg supporters 125 includes a panel having a first seating hole 126 for seating the washing machine leg 116, and a second seating hole 127 for seating a dryer leg 117, and is fastened to the top of the body 121 of the supplementary laundry treating machine 120 with screws. The washing machine and the dryer are modes of the laundry treating machine, wherein a mode is taken as an example, in which the exterior of the washing machine is greater than the exterior of the dryer.

The leg supporters 125 are fixedly secured to corners of the top of the body 121 of the supplementary laundry treating machine 120 respectively, wherein the first seating hole 126 and the second seating hole 127 of each of the two leg supporters at front corners of the body 121 of the pedestal supplementary laundry treating machine are joined with each other, and the first seating hole 126 and the second seating hole 127 of each of the two leg supporters at rear corners of the body 121 of the supplementary laundry treating machine are not pined with each other, for easy seating of the washing machine legs 116.

The first seating hole 126 is located on an outer side of the second seating hole 127 with respect to a diagonal line of the underside of the body 110 of the laundry treating machine. This is because, in general, the body of the washing machine is greater than the body of the laundry dryer.

The pining means 130 includes a joining member 138 provided to sides both of the washing machine or the laundry dryer, and the body 121 of the supplementary laundry treating machine under the washing machine or the laundry dryer, and fastening members 135 for fastening the joining member to the sides of the washing machine or the laundry dryer, and the body 121 of the supplementary laundry treating machine.

Referring to FIG. 3, the joining member may include two or more than two joining members 138 each for securing abutted sides of the body 121 of the hexahedral supplementary laundry treating machine, and the body 110 of the hexahedral laundry treating machine, to each other.

In addition to this, the joining member may also include a third fastening member (not shown) for securing abutted rear sides of the body 121 of the hexahedral supplementary laundry treating machine, and the body 110 of the hexahedral laundry treating machine, to each other.

In this instance, the joining means 130 may be designed to cope with height changes of the washing machine legs 116 or the laundry dryer legs 117.

The fastening member 135 includes a first fastening member 136 for securing an upper portion of the joining member to a lower portion of a side of the washing machine or the laundry dryer, and a second fastening member 137 for securing a lower portion of the joining member to an upper portion of a side of the pedestal.

In this instance, at least one of the first fastening member 136 and the second fastening member 137 may be one having adhesive applied to both sides, for an example, two sided tape.

Different from above, at least one of the first fastening member 136 and the second fastening member 137 may be fastening means, such as screws.

If the fastening member is screws, preferably, the upper portion of the joining member has fastening holes formed at fixed intervals.

In the meantime, different from above, the means for pining the body 110 of the laundry treating machine to the body 121 of the supplementary laundry treating machine can be changed in a variety of forms.

In the present invention, it is preferable that a volume of the body 121 of the supplementary laundry treating machine is smaller than a volume of the body 110 of the laundry treating machine to which the supplementary laundry treating machine is fastened. It is preferable that a height of the body of the supplementary laundry treating machine is lower than a height of the body of the laundry treating machine, because the object of the supplementary laundry treating machine in the present invention is to supplement the laundry treating machine.

In view of stability or exterior design of the composite laundry treating machine, it is preferable that at least one of a left/right direction width and a front/rear direction width of the body 121 of the supplementary laundry treating machine is the same or greater than a left/right direction width and a front/rear direction width of the body 110 of the laundry treating machine in a case the supplementary laundry treating machine serves as a pedestal of the laundry treating machine. However, in a case the supplementary laundry treating machine is fastened to the top of the laundry treating machine, it is preferable that at least one of the left/right direction width and the front/rear direction width of the body 121 of the supplementary laundry treating machine is the same or smaller than the left/right direction width and the front/rear direction width of the body 110 of the laundry treating machine.

The supplementary laundry treating machine will be described in detail with reference to FIG. 4.

FIG. 4 illustrates a section of a composite laundry treating machine with a supplementary laundry treating machine in accordance with a preferred embodiment of the present invention, schematically.

The supplementary laundry treating machine 120 may be pined with the body 110 of the laundry treating machine, to construct one composite laundry treating machine 100. In this case, the laundry treating machine has the laundry introduced to an inside of the body 110, for washing or drying, That is, the laundry treating machine may be a washing machine, a dryer, or a washing and drying machine.

The composite laundry treating machine 100 includes pining means 130 for securing the body 121 of the supplementary laundry treating machine to one side of the body 110 of the laundry treating machine. The pining means 130 is not shown in FIG. 4.

The supplementary laundry treating machine 120 has a laundry holding space formed therein for performing a supplementary function for laundry treatment. The laundry holding space may have a shape of a drawer 122 which can be drawn in a front direction toward the front of the body 121. The supplementary laundry treating machine 120 includes an air supply unit 140 in the body 121 of the supplementary laundry treating machine for forced supply of the air to the space.

As described before, it is preferable that the volume and the height of the body 121 of the supplementary laundry treating machine 120 are smaller and lower than the volume and the height of the body 110 of the laundry treating machine pined with the supplementary laundry treating machine 120.

The supplementary laundry treating machine 120 includes a steam supply unit 150 in the body 121 for supplying steam to the laundry holding space. The steam supply unit 150 has a spray hole (not shown) for spraying the steam to the space through the top or rear of the body.

In this instance, operation of the air supply unit 140 and the steam supply unit 150 is controlled by the control unit 123, and it is preferable that the control unit is provided to the front of the body 121. The control unit 123 may include a control panel for user's operation.

In the meantime, the control unit 123 can control operation of the supplementary laundry treating machine, separate from the control unit 111 of the laundry treating machine.

Of course, the operation of the supplementary laundry treating machine may be controlled with the control unit 111. In this case, the control unit 123 may be omitted, or may only function as a display window for displaying an operation state of the supplementary laundry treating machine to the user.

In a case the supplementary laundry treating machine is controlled with the control unit 111 of the laundry treating machine, it is required that the laundry treating machine and the supplementary laundry treating machine are wired for control or communication to each other. It is preferable that such a wired portion, i.e., connection portion (not shown) is formed. In the meantime, it is required that the connection portion is insulated against an electric current, and easy to connect, and reliability for the connection is secured.

The connection portion may include connectors (not shown) provided to a lower portion of the laundry treating machine and an upper portion of the supplementary laundry treating machine, respectively. The connectors have lines for communication or control connected thereto in a form of harness (not shown).

The connection portion includes, not only the connectors, but also insulating portions (not shown) for insulation. The insulating portions are formed on outside circumferences of the connectors respectively, for performing an insulating function when the connectors are connected. The insulating portions are formed of insulating material, preferably a material allowing compressed deformation to a certain extent, such as rubber and so on.

In the meantime, it is viable that the connector and the insulating portion are formed as a unit, and the insulating portion is formed only on either one of the connectors.

As described before, the laundry treating machine and the supplementary laundry treating machine are pined with the pining means 130 together, wherein the composite laundry treating machine may be designed such that the connectors are automatically connected at the time the laundry treating machine and the supplementary laundry treating machine are pined with the pining means.

In the meantime, the laundry treating machine and the supplementary laundry treating machine may respectively be provided with wireless communication modules or wired communication system which enable data input/output as means for mutual communication.

Accordingly, a state of the supplementary laundry treating machine is transmitted to the laundry treating machine by the communication module, such that the user determines the state of the supplementary laundry treating machine through the display window or the like provided to the laundry treating machine, and controls the supplementary laundry treating machine through the control unit 111 of the laundry treating machine. Such a control order is transmitted to the supplementary laundry treating machine through the connectors, to control the supplementary laundry treating machine.

Of course, the user may also determine the state of the supplementary laundry treating machine through the display window provided to the supplementary laundry treating machine, and controls the supplementary laundry treating machine through the control unit 111 of the laundry treating machine.

In the meantime, the air supply unit 140 includes a fan 141 for blowing air, and a heater 142 for heating the air. That is, as the fan 141 is driven, external air is introduced into the drawer 122, and discharged to an outside of the drawer, again. The external air is heated at the heater 142, and is introduced into the drawer 122.

Though the heater 142 may have a system selected from a variety of systems, such as electric type or a gas type, in view of nature of the supplementary laundry treating machine, it is preferable that the heater has the electric type, taking a mounting space into account.

Accordingly, the supplementary laundry treating machine 120 can perform a dry function by using the air supply unit 140. It is preferable that the heater 142 has a variable capacity for varying a temperature of the air heated with the heater, because certain fabrics are weak to heat, and rubber of shoes and so on are weak to heat, too.

The steam supply unit 150 supplies the steam to the drawer. The steam is brought into contact with laundry in the drawer, to sterilize and remove creases from the laundry. Therefore, the supplementary laundry treating machine 120 can perform a refresh function by using the steam supply unit 150. Of course, the supplementary laundry treating machine 120 can perform the refresh function as well as the drying function.

In the meantime, it is preferable that the body 121 of the supplementary laundry treating machine has an inlet 171 in an upper portion of the rear wall for introduction of the air to the body 121, and an outlet 172 in a lower portion of the rear wall for discharging the air from the body 121. The drawer 122 is in communication with the inlet 171 through an upper portion of a rear wall thereof, and the drawer 122 is in communication with the outlet 172 through the upper portion of a rear wall thereof. Accordingly, external air is introduced to the drawer through the upper portion of the body 121 and the upper portion of the drawer, and discharged through the lower portion of the drawer and the lower portion of the rear wall of the body 121.

The fan 141 that causes an air flow and the heater 142 that heats the air may be mounted between the rear wall of the drawer and the rear wall of the body. However, the mounting locations of the fan 141 and the heater 142 are not limited to this, but the air supply unit 140 of the fan 141 and the heater 142 can be mounted to anywhere on an flow passage through which the air is introduced/discharged.

FIG. 4 illustrates a mode in which the air is introduced through the upper portion of the drawer and discharged through the lower portion of the drawer. However, opposite to this, the air may be introduced through the lower portion of the drawer and discharged through the upper portion of the drawer.

In the meantime, referring to FIG. 4, the laundry 162 is seated in the drawer 122, and the drawer 122 may have a rack 160 which divides the inside space of the drawer in an upper portion and a lower portion while making the upper portion and the lower portion in communication. Such a rack is provided for smooth discharge of the air supplied to the laundry 162.

It is preferable that the rack has a plurality of pass through holes 160a. That is, air flows from the upper portion of the drawer to the lower portion of the drawer through the pass through holes.

Moreover, the rack may be tilted. In this case, it is preferable that the rack is tilted down in a direction of air inlet, for uniform supply of the air to the laundry seated on the rack.

It is preferable that the drawer has an air Side 161 at the upper portion of the rear wall, for smooth supply of the air up to a front of the drawer and functioning to separate an air introduction flow passage from an air discharge flow passage, which minimizes collision between air being introduced and air being discharged for enhancing efficiency of drying.

In the meantime, a variety of drying modes may be performed by using the supplementary laundry dryer of the present invention.

At first, the user draws out the drawer 122, and seats the laundry 162, such as a small amount of fabric or shoes, or a cap, on the rack 160. If the laundry is the fabric, it is preferable that the fabric is spread on the rack.

Then, the user selects a desired operation mode at the control unit 123 having the control panel according to a kind of the laundry. The operation mode may be one of a variety of the drying modes, or the refresh mode.

The variety of the drying modes may be modes of various drying time periods, or various drying temperatures, which are varied with kinds of laundry to be dried. For an example, for drying a small amount of fabric of cotton, the drying mode may be set, in which the drying time period is short and the drying temperature is high, and for drying shoes, the drying mode may be set, in which the drying time period is long and the drying temperature is low.

Though the air is forcibly supplied to the space having the laundry placed therein according to the operation mode the user selects, the air temperature and the air supply time period are varied.

Moreover, if the operation mode is the refresh mode, high temperature steam is supplied to the laundry. According to this, refresh of the laundry is made with the steam. That is, deodoring, removal of creases, or sterilizing of laundry is made. Then, air may be supplied as required for drying.

### INDUSTRIAL APPLICABILITY

The provision of a supplementary laundry treating machine which can treat small amount of laundry without driving a relatively large sized laundry treating machine permits convenience in use and energy saving.

A drying function can be added to a laundry treating machine with a washing function only, easily.

Drying of laundry, such as shoes or cap which has been difficult to dry with a related art drum type dryer can be dried easily, and a space of the pedestal of the related art laundry treating machine, unused in the related art, can be utilized as the supplementary laundry treating machine.

Thus, the present invention can provide a composite laundry treating machine which is convenient to use as the composite laundry treating machine maximizes utilization of space at a low cost.

1. A supplementary laundry treating machine comprising:
a body having a space formed therein for holding laundry;
an air supply unit in the body for supplying air to the space for holding laundry; and
joining means for securing the body to one side of a laundry treating machine having a volume and a height greater than a volume and a height of the body, respectively.

2. The machine as claimed in claim 1, wherein the air supply unit includes;
a fan for blowing air, and
a heater for heating the air being blown by the fan.

3. The machine as claimed in claim 2, further comprising a control unit for controlling operation of the air supply unit.

4. The machine as claimed in claim 3, wherein the control unit is provided to a front of the body.

5. The machine as claimed in claim 3, further comprising a steam supply unit in the body for selective supplying steam to the space for holding laundry under the control of the control unit.

6. The machine as claimed in claim 1, wherein the supplementary laundry treating machine is located under the laundry treating machine.

7. The machine as claimed in claim 6, wherein the space for holding laundry has a shape of a drawer which can be drawn forward from the front of the body.

8. The machine as claimed in claim 7, wherein the body has a rear wall with an inlet for introduction of the air into the body and an outlet for discharging the air from the body.

9. The machine as claimed in claim 8, wherein a rear wall of the drawer is in communication with the inlet and the outlet, respectively.

10. The machine as claimed in claim 9, wherein the air supply unit and the steam supply unit are provided between the rear wall of the drawer and the rear wall of the body.

11. The machine as claimed in claim 9, further comprising a rack which divides an inside of the drawer into an upper portion and a lower portion while allowing the upper portion and the lower portion to be in communication with each other for placing the laundry thereon.

12. The machine as claimed in claim 11, wherein the rack is tilted.

13. The machine as claimed in claim 12, wherein the rack is tilted down toward the air supply unit.

14. The machine as claimed in claim 9, further comprising an air guide extended to an inner side of the drawer for guiding the air.

15. A method for controlling a supplementary laundry treating machine having a space formed therein for holding laundry therein and selective blow of air thereto secured to one side of a laundry treating machine, comprising the steps of:
a mode selecting step for the user to select an operation mode; and
a drying step for supply of air to the space for holding laundry, with an air temperature and an air supply time period varied with the operation mode the user selects.

16. The method as claimed in claim 15, wherein the operation mode includes a refresh mode for refreshing the laundry.

17. The method as claimed in claim 16, wherein, if the refresh mode is selected in the mode selecting step, a steam supply step is performed for supplying the steam to the space for holding laundry before the drying step.

18. A composite laundry treating machine comprising:
a laundry treating machine for washing or drying laundry held in a body; and
a body of a supplementary laundry treating machine secured to one side of the body of the laundry treating machine with joining means, the body having a volume and a height smaller and lower than a volume and a height of the laundry treating machine respectively, and a space for holding laundry therein, and including an air supply unit provided therein for supplying air to the space for holding laundry.

19. The machine as claimed in claim 18, further comprising a steam supply unit in the supplementary laundry treating machine for supply steam to the space for holding laundry.

20. The machine as claimed in claim 18, further comprising a control unit for controlling operation of the laundry treating machine, and a control unit for controlling operation of the supplementary laundry treating machine, wherein the control units are independent from each other.

21. The machine as claimed in claim 18, further comprising a control unit for controlling both operation of the laundry treating machine, and operation of the supplementary laundry treating machine.

22. The machine as claimed in claim 21, wherein the control unit is provided to the body of the laundry treating machine.

23. The machine as claimed in claim 21, further comprising connection means for communication or control between the laundry treating machine and the supplementary laundry treating machine.

24. The machine as claimed in claim 23, wherein the connection means includes connectors for connecting various kinds of cable between the laundry treating machine and the supplementary laundry treating machine for communication or control therebetween, wherein, if the laundry treating machine and the supplementary laundry treating machine are pined with the pining means, the connector is connected, automatically.

25. The machine as claimed in claim 21, further comprising communication means for data communication between the laundry treating machine and the supplementary laundry treating machine.

26. The machine as claimed in claim 25, wherein the communication means comprises communication modules provided to the laundry treating machine and the supplementary laundry treating machine respectively, for enabling wire or wireless communication.

27. The machine as claimed in claim 18, wherein the supplementary laundry treating machine is located under the laundry treating machine.

28. The machine as claimed in claim 27, wherein the pining means includes;
a plurality of joining members each provided to sides both of the laundry treating machine, and the supplementary laundry treating machine, and
fastening members for fastening the pining member to the sides both of the laundry treating machine, and the supplementary laundry treating machine.

29. The machine as claimed in claim 28, wherein the fastening member includes;
a first fastening member for fastening an upper portion of the pining member to the side of the laundry treating machine, and
a second fastening member for fastening a lower portion of the pining member to the side of the supplementary laundry treating machine.

30. The machine as claimed in claim 29, wherein at least one of the first and second fastening members includes a tape.

31. The machine as claimed in claim 29, wherein at least one of the first and second fastening members includes a screw.
